(19) United States
(12) Patent Application Publication
(10) Pub. No.: US 2020/0371516 A1
(43) Pub. Date: Nov. 26, 2020

(54) METHOD AND DEVICE FOR TELEOPERATING A VEHICLE

(71) Applicant: Robert Bosch GmbH, Stuttgart (DE)

(72) Inventors: Erik Walossek, Giesen (DE); Frederik Blank, Ludwigsburg (DE); Kurt Eckert, Ditzingen (DE); Alexander Geraldy, Hildesheim (DE); Behzad Benam, Leonberg (DE); Jan Wolter, Hannover (DE); Jens Schwardmann, Hildesheim (DE); Karl Theo Floess, Heilbronn (DE)

(21) Appl. No.: 16/870,142

(22) Filed: May 8, 2020

(30) Foreign Application Priority Data
May 23, 2019 (DE) 102019207547.9

(51) Int. Cl. G05D 1/00

(52) U.S. Cl. CPC G05D 1/0027; G05D 1/0088; G05D 1/0061

(57) ABSTRACT

A method for teleoperating a vehicle. The method includes the following features: available operators are registered; data regarding the vehicle are received; operators who are selected from the available operators based on the data are communicated to the vehicle; a preferred operator among the selected operators is noted; communication resources are reserved; and the preferred operator is prompted to connect to a communication unit of the vehicle and to take over a control function of the vehicle with the aid of the communication unit.

### CROSS REFERENCE

The present application claims the benefit under 35 U.S.C. § 119 of German Patent Application No. DE 102019207547.9 filed on May 23, 2019, which is expressly incorporated herein by reference in its entirety.

### FIELD

The present invention relates to a method for teleoperating a vehicle. The present invention moreover relates to a corresponding device, to a corresponding computer program, as well as to a corresponding storage medium.

### BACKGROUND INFORMATION

(Semi-)autonomous vehicles according to the related art at present still include a vehicle driving interface (“driver work station”) and at present still require a person who is fit to drive and authorized to drive the vehicle as a vehicle occupant, who is able to take over driving the vehicle if necessary. Depending on the degree of automation and technological progress, it is planned in the future to dispense with the need for a driver who is fit to drive to take over within the vehicle in critical situations in sections or for the entire driving route. To nonetheless be able to circumvent system imponderables or shortcomings, numerous research projects are working on the so-called teleoperated driving (ToD) against this background. During ToD, the driving task and/or the vehicle may be intermittently supported and/or entirely taken over by an external user in a control center, the so-called operator, by way of remote control for the management of technical shortcomings of the (semi-)autonomous driving system or challenging scenarios, such as detours via alternative or unconventional roadways or routes, or the like. The vehicle and the control center or its operators are connected to one another for this purpose by a mobile communication network having a low latency and a high data rate.

U.S. Pat. No. 9,494,935 B2 describes computer devices, systems and methods for remotely operating an autonomous passenger vehicle. When an autonomous vehicle encounters unexpected surroundings, such as a road construction site or an obstacle, not suitable for autonomous operation, the vehicle sensors may collect data about the vehicle and the unexpected surroundings, including images, radar and LIDAR data, etc. The collected data may be transmitted to a remote operator. The remote operator may remotely operate the vehicle manually or issue instructions to the autonomous vehicle, which are to be carried out by different vehicle systems. The collected data transmitted to the remote operator may be optimized to save bandwidth, for example by transmitting a limited subset of the collected data.

A vehicle is described in U.S. Pat. No. 9,767,369 B2 which may receive one or multiple image(s) of surroundings of the vehicle. The vehicle may also receive a surroundings map. The vehicle may also compare at least one feature in the images to one or multiple feature(s) in the map. The vehicle may also identify a certain area in the one or the multiple image(s), which corresponds to a portion of the map situated at a threshold distance from the one or the multiple feature(s). The vehicle may also compress the one or the multiple image(s) or sensor signal(s) to record a smaller number of details in the recording areas than in the given area. The vehicle may also provide the compressed images to a remote system and, in response thereto, receive operating instructions from the remote system.

Systems and methods described in U.S. Pat. No. 9,465,388 B1 enable an autonomous vehicle to request assistance from a remote operator when the confidence of the vehicle in the operation is low, or a technical problem or a technical shortcoming or an external situation makes it necessary. An exemplary method encompasses the operation of an autonomous vehicle in a first autonomous mode. The method may also encompass the identification of a situation in which a confidence level of an autonomous operation in the first autonomous mode is below a threshold level. The method may furthermore encompass the transmission of a request for assistance to a remote assistant, the request including sensor data representative of a portion of surroundings of the autonomous vehicle. The method may additionally encompass the reception of a response from the remote assistant, the response indicating a second autonomous operating mode. The method may also cause the autonomous vehicle to operate in the second autonomous operating mode according to the response from the remote assistant.

U.S. Pat. No. 9,720,410 B2 describes a further method for remotely assisting autonomous vehicles in predetermined situations.

### SUMMARY

The present invention provides a method for teleoperating a vehicle, a corresponding device, a corresponding computer program, as well as a corresponding machine-readable storage medium.

One advantage of example embodiments of the present invention lies in the option it opens up of an (optimized) assignment of operators for the teleoperated driving to automated vehicles which request or are already using this service, and the dynamic change of these operators. For this purpose, existing communication resources and ToD service providers are gathered and evaluated to be able to ensure an efficient use of these resources. By using redundant transmission paths and mediation between the ToD service providers, low latencies may be ensured, which enables a seamless change of the ToD service providers. In this way, it is possible to carry out teleoperated driving even under difficult boundary conditions or to operate preferably many vehicles simultaneously by a corresponding distribution among available ToD service providers. A dispatcher is used for the initial mediation, taking the available resources necessary for the driving operation into consideration, between the vehicle and the operator, and for the handover of vehicles already being controlled between the different service providers.

Certain measures described herein allow advantageous refinements of and improvements present invention. It may be provided, for example, that the service companies each operate one or multiple (locally distributed or competence- and task-oriented) control center(s), whose operators are assigned by a (automated or human or a combination of both) control center dispatcher. The dispatcher manages all resources and capabilities within his or her control center(s) and reports these, together with their availability, to the dispatcher service or services. Depending on the size of the company (number of the control centers), company-internal dispatcher functions may also be implemented, specifically when fleet operators operate their own control center network. In this way, a scalable ToD approach is created, which is able to process simultaneous ToD requests for a plurality of vehicles in a time-efficient manner as needed by utilizing dispatcher services (using a centralized or also in combination with a distributed or hierarchical dispatcher architecture). In the process, ToD requests and ToD operators are brought together by analyzing, managing and cooperatively using different transmission paths, existing ToD service provider resources and ToD operators, the necessary ToD assistance, and the ToD qualification.

According to one further aspect of the present invention, it may be provided that the second operator requests the control function from the first operator for the handover of the control function from a first operator to a second operator, the handover only being carried out after the second operator has completely taken over the control function. One advantage of this specific embodiment is the implementation of a seamless change of the operator even while a driving maneuver is ongoing, to be able to use the matching operator having an appropriate release level (suitability) as a function of the required ToD driving situation, hazard level, and knowledge of the location.

### BRIEF DESCRIPTION OF THE DRAWINGS

Exemplary embodiments of the present invention are shown in the figures and are described in greater detail below.

FIG. 1 schematically shows a vehicle connected to the cloud.

FIG. 2 shows the block diagram of an infrastructure.

FIG. 3 shows the flow chart of a method.

### DETAILED DESCRIPTION OF EXAMPLE EMBODIMENTS

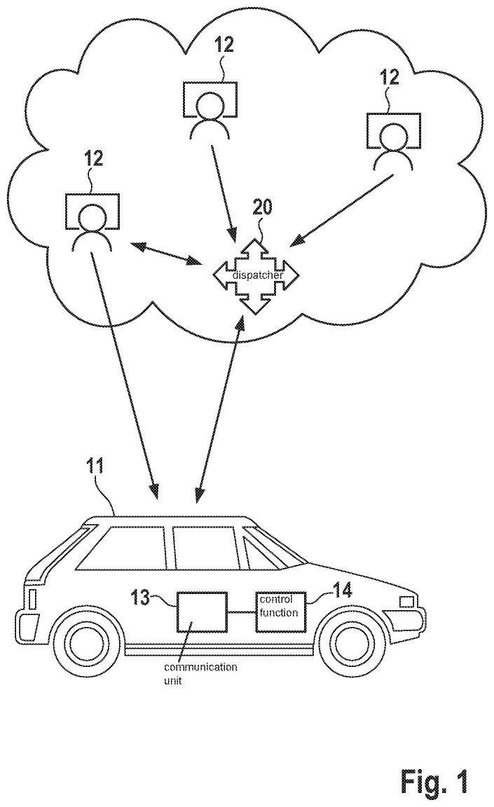

FIG. 1 illustrates an overall view an example approach described hereafter in detail: When an automated vehicle 11 finds itself in a situation which it is not able to manage independently, or if it recognizes a system degradation (e.g., with the aid of its vehicle diagnostic system) which requires assistance, it transmits an assistance request to a so-called dispatcher 20. Dispatcher 20 evaluates the reason for the error transmitted by vehicle 11, or analyzes the situation of vehicle 11, based on the vehicle, error or sensor data available to him or her, and forwards the request to a ToD service provider who has the necessary operator resources and capabilities to restore the regular driving operation of vehicle 11 or effectuate an operationally safe state, if the circumstances, e.g., due to defects, no longer allow keeping vehicle 11 in operation.

For this purpose, a ranking of dispatchers 20 is transmitted to vehicle 11 at the latest at the start of the automated driving function. For safety reasons, basic principles of redundancy are employed in the process, for example by using multiple lists and dispatcher service centers. It is also possible for multiple such lists to exist, which are used as a function of the error criticality to deliberately establish a direct link in emergencies. These lists are regularly updated, e.g., also in accordance with the vehicle position and the availability of the dispatchers.

If vehicle 11, during the driving operation, enters a non-specified state or if a technical shortcoming or the need for remote assistance by the vehicle is established, it transmits the request to transfer the driving function to an operator 12 belonging to a ToD service provider to the first dispatcher 20 from this list. This request typically includes the following pieces of information:
the surroundings of vehicle 11, such as its location and objects it identified;
the planned route or relevant operating modes;
the vehicle type and manufacturer or the vehicle configuration;
the criticality ascertained by vehicle 11 or dispatcher 20 by way of a hazard analysis, for example with respect to the hazard potential and time window, at least the transfer into a safe state being pursued;
the communication quality or a classification of the transmission channel;
potential errors identified by vehicle 11, or the type and extent of the desired service; and
if necessary, hardware and software versions of individual components 13, 14 installed in vehicle 11, which are necessary for the ToD functionality or could have an effect thereon.

During the classification of the transmission channels (typing) and the associated establishment of their suitability for a method according to the present invention, pieces of information about the latency, bandwidth, effective data throughput (dependent on the bit error rate) and network coverage of the transmission medium in the entire area of use are desirable. The quality of service of the transmission channel ascertained in the vehicle may also be used accordingly.

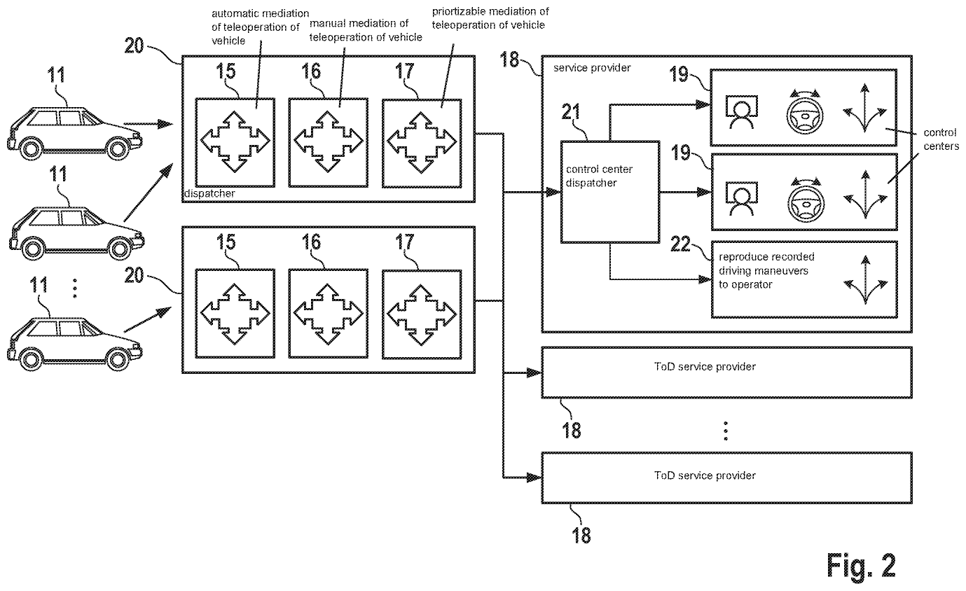

FIG. 2 illustrates an infrastructure according to the present invention as a whole. As its core component, dispatcher 20 mediates requests between operators 12 provided by ToD service providers 18 and the ToD resources required by vehicles 11. Many different vehicles 11 are assigned to many different operators 12 of ToD service providers 18 based on their suitability, determinable by existing resources and capabilities, which enables an optimal utilization. For this purpose, ToD service providers 18 transmit, among other things, the following pieces of status information at regular intervals, or changes, to dispatchers 20:
supported driving situations;
supported hazard levels;
existing knowledge of the location;
instantaneously available operators 12 having appropriate capabilities;
instantaneously available suitable equipment; or
supported vehicle types.

Dispatcher 20 relays the handover of ToD inquiries from vehicles 11 to ToD service providers 18 and their suitable operators 12. During an ongoing driving maneuver, dispatcher 20 may additionally enable a handover both between ToD service providers 18 and between operators 12 to enable their seamless change, and to minimize the latency itself during the teleoperation of a mobile vehicle 11. For safety reasons, all operations preferably take place using redundant transmission paths. In addition, dispatcher 20 controls the cooperative use of transmission channels by coordination among all instantaneous participants. To evaluate the transmission capacities, a classification of the transmission channels is desirable. Furthermore, the resources required may be determined as a function of the type of control function 14. In this way, it is possible to ascertain whether it is even feasible to carry out a control, or whether even multiple controls are possible simultaneously. After the identification of the transmission resources required for the imminent control functions, taking features, such as technology (latency), bandwidth and redundancy (functional safety) into consideration, these may be allocated by the dispatcher across systems, e.g., using a shared database, and assigned to vehicle 11 and ToD service providers 18 for implementing the driving maneuver or the driving function.

As a function of the above-mentioned properties and the availability or the training of operators 12, either entire driving maneuvers in real time, up to certain speeds, or only the release of individual actions or, if necessary, only the transmission of trajectories for a vehicle 11 or only a monitoring of pieces of sensor information is possible for a ToD operation. As a function of the above-mentioned properties and the availability or the training of operators 12, the different ToD operations may possibly be implemented simultaneously for different vehicles or only sequentially in accordance with a prioritization by dispatchers.

All actions described here should take place taking the functional safety [FuSa] into consideration. A recording of the implemented actions, as it is practiced in the aviation industry with the aid of a so-called black box, for example, should take place in vehicle 11 or also additionally at ToD service provider 18.

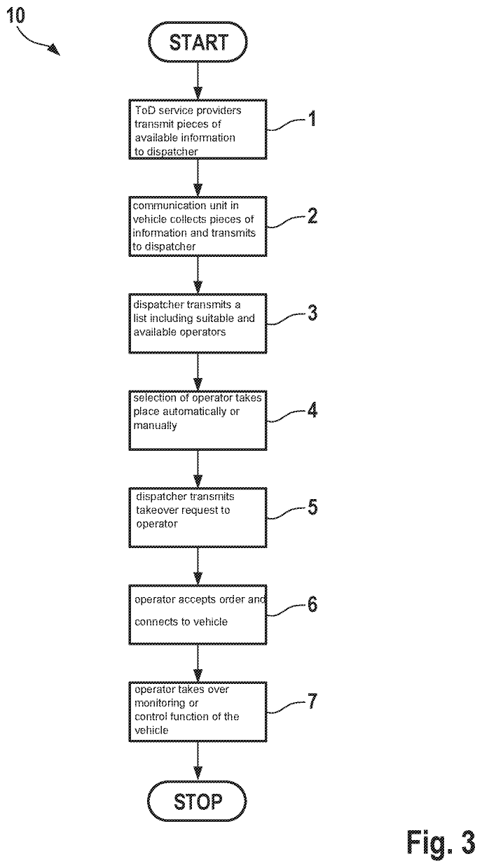

The regular mode of operation of a dispatcher 20 during the coupling of a vehicle (11) with a ToD operator 12 shall now be explained with additional reference to FIG. 3:
1. All available ToD service providers 18 transmit the pieces of information available to them to dispatcher 20. For example, the respective capacities and services, together with price information, and the territory in which the service is offered (process 1, FIG. 3) are possible.
2. A communication unit 13 in vehicle 11 collects pieces of information and transmits them to dispatcher 20. This includes, for example, the type and number of the transmission routes, including their classification, the present situation (speed, location, route, type of the flow disruption, estimation of the criticality of a driving situation, etc.), pieces of service contract information, vehicle type, as well as hardware and software statuses (process 2, FIG. 3).
3. Dispatcher 20 transmits a list including suitable and available operators 12 of a matching release level and including appropriately sufficient transmission resources matched to the vehicle, including their costs, to vehicle (process 3, FIG. 3).
4. The selection of operator 12 takes place automatically (based on stored selection criteria) or manually by a vehicle occupant with the aid of a transmitted selection list (process 4, FIG. 3).
5. Dispatcher 20 reserves the transmission resources necessary for the type of control, taking technology (latency), bandwidth and redundancy (functional safety) into consideration.
6. Dispatcher 20 transmits a takeover request to the operator (process 5, FIG. 3).
7. Operator 12 accepts the order and connects to the vehicle (process 6, FIG. 3).
8. Operator 12 takes over the monitoring or control function 14 of the vehicle, as a function of the allowed release level and transmission quality (process 7, FIG. 3).

A handover between service providers 18, e.g., because a vehicle 11 identifies the change into a new area of responsibility of a service provider 18, could then take place as follows:
1. If the remotely controlled vehicle 11 establishes that the vehicle will leave, or has left, the area of responsibility of the present operator/ToD service provider 18, communication unit 13 in vehicle 11 transmits a corresponding ToD request, including the relevant pieces of information regarding the driving situation, to dispatcher 20.
2. Dispatcher 20 transmits a list including possible operators 12, including their costs, to vehicle 1). The present ToD operator 12 is informed and, depending on the situation, may object to a change at the present point in time.
3. Vehicle 11 with its communication unit 13 and ToD system independently selects a corresponding new service provider 18 or asks the vehicle occupant to select a new service provider 18. If the selection does not take place in a timely manner, depending on the driving situation, ToD operator 12 may make a selection, or ToD operator 12 is prompted to transfer vehicle 11 into a safe state. Corresponding feedback is provided to dispatcher 20.
4. Dispatcher 20 thereupon contacts operators 12 and informs them about the imminent change.
5. The first operator 12 transfers all data necessary for the ToD driving operation to the second operator 12.
6. The second operator 12 connects to vehicle 11 and, if necessary upon coordination with the first operator 12 by telephone, familiarizes himself or herself with the driving situation.
7. When the second operator 12 is ready to take over, he or she transmits a request for the final handover of the control to the first operator 12, who has to confirm the request. After the confirmation, the second operator thus also symbolically assumes the responsibility.
8. The first operator 12 may still make sure for a certain time that the second operator 12 is able to handle the situation, and thereafter terminates the link to vehicle 11. In this way, his or her resources are released again. If the second operator 12 is not successful in handling the situation, a request for taking over again may be returned to the first operator. The first operator has to confirm this request. With this, the responsibility is symbolically transferred back from the second to the first operator 12, who thus assumes the control again, if necessary with losses with respect to the service quality or tolerating a higher consumption of resources, and dispatcher 20 refers a new, third operator 12, according to the example method highlighted hereafter, or the first operator 12 transfers vehicle 11 into a safe state, such as by parking, if he or she is no longer able to handle the instantaneous driving situation.

A handover between ToD operators 12, e.g., because a ToD operator 12 is not able to complete his or her present task, e.g., because an operator does not have the necessary release level (qualification level), or because the vehicle is leaving the area of responsibility of the ToD operator, is thus as follows on this basis:
1. ToD operator 12 controls a vehicle 11, but is not able to continue this control, e.g., because a higher qualification is necessary to do so, or because he or she is not able to independently remedy a problem, or he or she establishes that the vehicle is leaving his or her area of responsibility.
2. ToD operator 12 initiates a change of operator 12 or service provider 18 by returning a request in this regard, specifying the necessary assistance and qualification of the new, second operator 12 or provider 18, either via vehicle 11 for confirmation and forwarding to dispatcher 20, or by transmitting it directly to dispatcher 20 in accordance with existing service contracts for the reassignment of the ToD order. For safety reasons, the first ToD operator 12 may also request a change naming a direct suitable second ToD operator 12 in the immediate surroundings of the first ToD operator 12. The latter request may take place directly or be relayed further by control center dispatcher 21 of service provider 18. The dispatcher is appropriately informed about the request and mediates between the two operators.
3. The further procedure corresponds to steps 4 through 9 described above for a handover between service providers 18.

The behavior in special situations warrants attention. For example, if two semi-automated or even autonomous vehicles 11, e.g., when encountering one another on a narrow road, block one another, this blockage (deadlock) may be resolved by both vehicles 11 transmitting a ToD request, operators 12 establishing contact with one another, and resolving the situation. The establishment of contact with another operator 12 is possible, for example, by the first operator 12, e.g., indicating the official license number of the other vehicle 11, transmitting a contact request via dispatcher 20.

It may become necessary to manage requests in queues, comparable to the “on-hold loops” known from call centers, in the event of a lack of availability of ToD operators 12 or an overload of the transmission channel or other resources. A processing of requests deviating from the order in which they were received may be advisable, for example, in the event of imminent danger, e.g., on expressways at high speed or in emergencies, for the dispersion of traffic jams through tactical action based on the positions of the individual vehicles 11, in light of the scope and complexity of the imminent intervention or as a function of the type of the acquired service (premium, standard, basic, eco, etc.).

To save transmission bandwidth and resources at the ToD service provider 18, (transmission) resources may be pooled under predefined boundary conditions. It is also possible that recently carried out driving maneuvers are reused in the same place in a partially automated manner. This applies when, for example in the case of jammed traffic, e.g., due to an accident, an obstacle which was already overcome by another teleoperated vehicle 11 was successfully circumnavigated, and one of the following vehicles in the same situation requires the same assistance, given the circumstances and system properties. For example, a trajectory may thus be recorded by a ToD operator (12) during the remotely controlled driving and made available to other ToD operators 12 or semi-automatedly following vehicles 11. Here as well, the request to have multiple vehicles 11 consecutively follow one another to form a convoy (platoon) for pooling requests, which should then all follow an identical trajectory to circumnavigate the hazardous situation, is a suitable method.

Example embodiments of the present invention are further described in the following paragraphs.

Paragraph 1. A method (10) for teleoperating a vehicle (11), characterized by the following features:
available operators (12) are registered (1);
data regarding the vehicle (11) are received (2);
operators (12) who are selected from the available operators (12) based on the data are communicated to (3) the vehicle (11);
a preferred operator (12) among the selected operators (12) is noted (4);
communication resources are reserved; and
the preferred operator (12) is prompted (5) to connect (6) to a communication unit (13) of the vehicle (11) and to take over (7) a control function (14) of the vehicle (11) with the aid of the communication unit (13).

Paragraph 2. The method (10) as recited in Paragraph 1, characterized by the following features:
during the registration of the operators (12) a service offer is noted in each case, and
the operators (12) are furthermore selected in each case based on service offer.

Paragraph 3. The method (10) as recited in Paragraph 2, wherein the service offer encompasses at least one of the following:
an automatic mediation (15) of the teleoperation of the vehicle (11);
a manual mediation (16) of the teleoperation of the vehicle (11); or
a prioritizable mediation of the teleoperation of the vehicle (11) in critical (17) traffic situations.

Paragraph 4. The method (10) as recited in Paragraph 3, characterized by the following features:
each of the operators (12) belongs to a service company (18);
the service company (18) operates one or more control centers (19); and
the operators (12) of the control centers (19) are assigned.

Paragraph 5. The method (10) as recited in Paragraph 4, wherein the assignment of the operators (12) of the control centers (19) takes place based on at least one of the following criteria:
an emergency of the vehicle (11);
a compatibility of the control center with the vehicle (11) to be controlled;
access authorization of the control center to the vehicle (11) to be controlled;
a skill of the operators (12);
a utilization of the control centers (19); or
a possible pooling and partial automation of the ToD instruction.

Paragraph 6. The method (10) as recited in Paragraph 4 or 5, characterized by the following features:
driving maneuvers of the vehicle (11) carried out by the operators (12) in a given traffic situation are recorded by the service company (18);
the recorded driving maneuvers may be reproduced (22) by an operator (12) when the traffic situation repeats itself during a teleoperation; and
a possible approach trajectory may be proposed to the vehicle (11) manually or semi-automatedly.

Paragraph 7. The method (10) as recited in Paragraph 4, 5 or 6, characterized by the following features:
the vehicle (11) may be prompted to join a vehicle convoy; and
a possible approach trajectory may be proposed to the vehicle convoy manually or semi-automatedly by the operator; or
the vehicle convey is controlled directly by an operator.

Paragraph 8. The method (10) as recited in one of Paragraphs 1 through 6, characterized by the following features:
in the case of a planned handover of the control function (14) from a first operator (12) to a second operator (12), the first operator (12) and the second operator (12) are notified;
the second operator (12) requests the control function (14) from the first operator (12); and
the handover is carried out when the second operator (12) has completely taken over the control function (14).

Paragraph 9. A computer program, which is configured to carry out the method (10) as recited in one of Paragraphs 1 through 7.

Paragraph 10. A machine-readable storage medium on which the computer program as recited in Paragraph 8 is stored.

Paragraph 11. A device (20), which is configured to carry out the method (10) as recited in one of Paragraphs 1 through 7.

What is claimed is:

1. A method for teleoperating a vehicle, comprising the following steps:
registering available operators;
receiving data regarding the vehicle;
communicating to the vehicle operators selected from the available operators based on the received data;
selecting a preferred operator from among the selected operators;
reserving communication resources; and
prompting the preferred operator to connect to a communication unit of the vehicle and to take over a control function of the vehicle using the communication unit.

2. The method as recited in claim 1, further comprising the following step:
during the registration of the operators, identifying a service offer in each case; and
wherein the operators are furthermore selected in each case based on the service offers.

3. The method as recited in claim 2, wherein the service offer encompasses at least one of the following:
an automatic mediation of the teleoperation of the vehicle; and/or
a manual mediation of the teleoperation of the vehicle; and/or
a prioritizable mediation of the teleoperation of the vehicle in critical traffic situations.

4. The method as recited in claim 3, wherein:
each of the operators belongs to a service company;
the service company operates one or more control centers; and
the operators of the control centers are assigned.

5. The method as recited in claim 4, wherein the assignment of the operators of the control centers takes place based on at least one of the following criteria:
an emergency of the vehicle; and/or
a compatibility of the control center with the vehicle to be controlled; and/or
access authorization of the control center to the vehicle to be controlled; and/or
a skill of the operators; and/or
a utilization of the control centers; and/or
a possible pooling and partial automation of a ToD (teleoperated driving) instruction.

6. The method as recited in claim 4, further comprising the following steps:
recording, by the service company, driving maneuvers of the vehicle carried out by the operators in a given traffic situation;
reproducing the recorded driving maneuvers, by an operator, when the traffic situation repeats itself during a teleoperation; and
proposing a possible approach trajectory to the vehicle manually or semi-automatedly.

7. The method as recited in claim 4, further comprising the following steps:
prompting the vehicle to join a vehicle convoy; and
(i) proposing a possible approach trajectory to the vehicle convoy manually or semi-automatedly by the operator, or (ii) directly controlling the vehicle convey by an operator.

8. The method as recited in claim 1, further comprising the following steps:
planning a handover of the control function of the vehicle from a first operator to a second operator;
notifying the first operator and the second operator of the handover;
requesting, by the second operator, the control function from the first operator; and
carrying out the handover when the second operator has completely taken over the control function.

9. A non-transitory machine-readable storage medium on which is stored a computer program for teleoperating a vehicle, the computer program, when executed by a computer, causing the computer to perform the following steps:
registering available operators;
receiving data regarding the vehicle;
communicating to the vehicle operators selected from the available operators based on the received data;
selecting a preferred operator from among the selected operators;
reserving communication resources; and
prompting the preferred operator to connect to a communication unit of the vehicle and to take over a control function of the vehicle using the communication unit.

10. A device for teleoperating a vehicle, the device configured to:
register available operators;
receive data regarding the vehicle;
communicate to the vehicle operators selected from the available operators based on the received data;
select a preferred operator from among the selected operators;
reserve communication resources; and
prompt the preferred operator to connect to a communication unit of the vehicle and to take over a control function of the vehicle using the communication unit.
